(19) United States
(12) Patent Application Publication
(10) Pub. No.: US 2024/0256958 A1
(43) Pub. Date: Aug. 1, 2024

(54) STORING ENTRIES IN AND RETRIEVING INFORMATION FROM AN EPISODIC OBJECT MEMORY

(71) Applicant: Microsoft Technology Licensing, LLC, Redmond, WA (US)

(72) Inventors: Eric Joel HORVITZ, Portola Valley, CA (US); Nicholas BECKER, Boulder, CO (US)

(73) Assignee: Microsoft Technology Licensing, LLC, Redmond, WA (US)

(21) Appl. No.: 18/204,725

(22) Filed: Jun. 1, 2023

Related U.S. Application Data
(60) Provisional application No. 63/441,903, filed on Jan. 30, 2023.

(51) Int. Cl. G06N 20/00

(52) U.S. Cl. CPC G06N 20/00

(57) ABSTRACT

A method for identifying and storing a landmark memory in an episodic object memory is provided that includes receiving one or more content items. The content items each have one or more content data. The one or more content data associated with the one or more content items may be provided and integrated into one or more embedding models that represent a growing set of episodic memories. Episodic memory relates to the ability to recall content from one's personal past, such as in the form of landmark memories, which may be filtered from a plurality of memories based on a degree of salience. The one or more landmark memories and references to related content items are inserted into an episodic object memory for later recall and use in the course of context and task at hand.

### CROSS-REFERENCE TO RELATED APPLICATION

This application claims priority to U.S. Provisional Application No. 63/441,903, titled “STORING ENTRIES IN AND RETRIEVING INFORMATION FROM AN EPISODIC OBJECT MEMORY,” filed on Jan. 30, 2023, the entire disclosure of which is hereby incorporated by reference in its entirety.

### BACKGROUND

Human and machine-based intelligences are typified as working under constraints in sets of important cognitive resources, such as memory and computational capabilities required for recollection and reasoning. The boundedness of the efficiency with which a human or AI-based system can selectively encode experiences into short- and long-term memory and then later recall the most relevant information for a current context and task at hand motivates the need for mechanisms that can identify the most salient memories for storage and retrieval.

Whether human or artificial, agents may be exposed to a great deal of information about experiences encountered, including sensed information, problems encountered and solved, successes and failures with achieving goals, and encodings of reasoning processes and strategies. The experiences may include specific occurrences or events, important people, relationships, and locations, signals about rewards for behaviors or situations, and places, and learnings of new knowledge and strategies that can be applied many times in the future with or without custom-tailoring to solve problems more efficiently.

Processes for selectively encoding and accessing important memories, referred to herein as “landmark memories,” must select the landmark memories from an overwhelming quantity of experiences. Selectivity is important for endowing a cognitive system with the ability to efficiently store and retrieve information, when needed, that will be most valuable for maximizing its objectives.

Some systems may have efficient means for storing large quantities of experiences, but limited powers of recalling and reasoning about relevant content in a specific context. Landmark memories may be used as specific pointers into larger memory stores, enabling efficient organization of large quantities of stored information for efficient retrieval, such as landmarks that serve as easily accessed, recognizable “handles” into progressively more detailed memory. As an example, many times people desire to recall past events, but since memories are known to fail, it can be difficult for users to remember details from various moments of time. When trying to recall details, the users may remember at least some of the different types of contextual information related to their everyday lives. For instance, following a meeting, where many different topics are covered, a user may not remember all of them. However, the user may remember other aspects of the meeting, such as the location, one or more of the attendees, and the like. In fact, many events in our everyday lives comprise many different subsets of information, such as weather, location, people, news, sights, and sounds. While computing devices are able to collect weather data, location data, participant information, related news data, and other audio/video data, given the unstructured nature of such data, it is not helpful in user recall.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to methods, systems, and media for storing entries in and/or receiving information from an episodic object memory.

In some examples, one or more experienced content items are received that each have one or more content data. The one or more content data may be provided to a memory processor that creates or has access to one or more embedding models and that continues to work to integrate content into an organized metric space that captures regularized distances among different content data based on attributes of the data. A collection of embeddings may be received from one or more of the embedding models. In examples, an embedding may also be an embedding object that comprise multiple embeddings. Each embedding of the collection of embeddings may correspond to at least one content data from a respective content item. One or more embeddings of the collections of embeddings may be determined to be landmark memory embeddings by the memory processing apparatus. For example, the one or more of the embeddings may be ranked, weighted, and/or scored, such as based on a machine-learning model trained via supervised learning methods and/or a calculated dissimilarity to at least one of the other embeddings of the collection of embeddings. The landmark memory embeddings may be inserted into an episodic object memory that links the memory to other landmark memories based on relationships among one or more attributes of the landmarks such temporal and/or spatial relationships among content linked to the landmarks or other relationships such as social relationships among people or similarity in the context of application of content for problem solving. In this way, embeddings of landmark memories may bring together experienced content that is useful to have joint access to in real-time recognition and problem solving. Further, in some examples, an input (e.g., user-input) may be received that corresponds to a degree of salience of content stored and retrieved from the episodic memory.

This summary is provided to introduce a selection of concepts in a simplified form that are further described below in the Detailed Description. This summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTION OF THE DRAWINGS

Non-limiting and non-exhaustive examples are described with reference to the following Figures.

FIG. 1 illustrates an overview of an example system according to some aspects described herein.

FIG. 2 illustrates examples content data, according to some aspects described herein.

FIG. 3 illustrates an example flow of storing entries in an episodic object memory, according to some aspects described herein.

FIG. 4 illustrates an example vector space, according to some aspects described herein.

FIG. 5A illustrates an example method for storing a landmark memory in episodic object memory, according to some aspects described herein.

FIG. 5B illustrates an example method for determining that an embedding is a landmark memory embedding, according to some aspects described herein.

FIG. 6A illustrates an example system for retrieving information from an episodic object memory, according to some aspects described herein.

FIG. 6B illustrates an example system for retrieving information from an episodic object memory, according to some aspects described herein.

FIG. 7 illustrates an example method for retrieving information from an episodic object memory, according to some aspects described herein.

FIGS. 8A and 8B illustrate overviews of an example generative machine learning model that may be used according to aspects described herein.

FIG. 9 illustrates a block diagram illustrating example physical components of a computing device with which aspects of the disclosure may be practiced.

FIG. 10 illustrates a simplified block diagrams of a computing device with which aspects of the present disclosure may be practiced.

FIG. 11 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The first named inventor of the present disclosure, Eric J. Horvitz, is also the first named inventor of U.S. patent application Ser. No. 11/172,467, filed on Jun. 30, 2005, and entitled “Methods for Selecting, Organizing, and Displaying Images from Large Stores of Personal Content,” which describes systems and methods for automatically organizing, managing, and presenting information content in a manner that is relevant or personal to users.

Per the limitations in the cognitive resources for machines or people and the overwhelming complexity of the world which machines or people work, it can be difficult to store and retrieve important details about experienced content from various moments of time, in the everyday course of affairs. Computing devices can receive a plurality of different types of contextual information related to user's everyday lives, such as audio data, video data, gaze data, weather data, location data, news data, or other types of ambient data which may be recognized by those of ordinary skill in the art. A user may associate some of these different types of contextual or ambient information with details in their everyday lives, such as documents that were presented in meetings, emails that were sent on given days, conversations regarding specific topics, etc.

As humans, often, we associate memories with contextual information related to the memory that we are trying to recall. For example, when looking for a document on a computer, a user may remember that a significant news story was published when they last had the document open, or that it was storming outside when they last had the document open, or that they last accessed the document, via their smartphone, while travelling to a specific park. Additionally, or alternatively, the user may remember that they were on a phone call or video call with a specific person, when they last had the document open. However, the user's process of tracing their own memory associations to determine where to locate the document on one or more of their computing devices can be time consuming, frustrating, and unnecessarily consume computational resources (e.g., of a processor and/or of memory).

Further, in some examples, a user's computing device may record just a screen of the computing device, or just audio of the computing device, or just a location of the computing device, with the user's permission, such that the recording can be searched for associations that the user is trying to make, while trying to perform an action on their computing device (e.g., locate a document, open a document, send an email, schedule a calendar event, etc.). However, storing a recording (e.g., of video, audio, or a location) can occupy a relatively large amount of memory. Further, searching through the recording can be relatively time consuming and computationally expensive. Accordingly, there exists a need to improve user efficiency of performing actions on a computing device, based on landmark memories and associated contextual information.

The landmark memories described herein may be memories that a system and/or user distinguishes as important, unique, and/or distinct from other memories that may be stored. For example, a landmark memory may be distinguished because it is a memorable person, important transaction, meaningful portion of a file, or another distinguished piece of content that is useful to access for recalling past events. Landmark memories may have an associated structure of attributes, such as including dimensions of data about a memory that is determined to be a landmark memory. Landmark memories and their attributes can enable efficient, context-sensitive access of relevant experienced and encoded content using mechanisms provided herein.

Landmark memories may be a parent structure that has sub-structures, such as sub-landmark memories, with relationships to and/or between the sub-structures being stored. Accordingly, landmark memories may have relationships to one another, such as in place, people, task type, and/or time (as described with respect to the term “episodic memory” used throughout, which stems from psychology, and which those of ordinary skill in the art may recognize as having been originally-described by the teachings of psychologist Endel Tulving). For example, landmark memories may be proximal to each other, such as July 4^{th} and the explosion of fireworks, and a dinner party the night before, including the key attendees and salient aspects of the conversation. Additional and/or alternative examples may be recognized by those of ordinary skill in the art.

Accordingly, some aspects of the present disclosure relate to methods, systems, and media for storing a landmark memory in an episodic object memory. Generally, content items may be received that have one or more content data (e.g., emails, audio data, video data, messages, internet encyclopedia data, skills, commands, source code, programmatic evaluations, etc.). The one or more content data may be provided to models to generate a collection of embeddings (e.g., semantic embeddings). One or more embeddings from the collection of embeddings may be determined to be landmark memory embeddings. For example, the collection of embeddings may be ranked, weighted, scored, and/or provided to a trained machine-learning model to determine that the one or more embeddings are landmark memory embeddings. This may include models capable of making this determination that are potentially not trained directly to perform this task (i.e., via a transfer of skills). The one or more landmark memory embeddings may be inserted into the episodic object memory, such as with an indication corresponding to the ranking, weighting, scoring, etc. and/or with a reference to related data.

Additionally, or alternatively, some aspects of the present disclosure relate to methods, systems, and media for retrieving landmark memories from an episodic object memory. Generally, a user-interface may be generated via which an input is received that corresponds to a degree of episodic memory. An indication of one or more landmark memories may be received from the episodic memory, based on the degree of episodic memory.

Advantages of mechanisms disclosed herein may include an improved user efficiency for performing actions (e.g., retrieving information, locating a virtual document, generating a draft email, generating a draft calendar event, providing content information related to a virtual document, etc.) via a computing device, based on content that was summarized (e.g., via text and/or embeddings) and analyzed (e.g., ranked, weighted, scored, providing to a trained machine-learning model), based on the summarizations. Furthermore, mechanisms disclosed herein for generating an episodic can improve computational efficiency by, for example, reducing an amount of memory that is needed to track content (e.g., via feature vectors or labels, as opposed to audio/video recording, relative large amounts of text). Still further, mechanisms disclosed herein can improve computational efficiency for receiving content from an episodic object memory, such as by comparing feature vectors, as opposed to searching through relatively large recordings or repositories stored in memory.

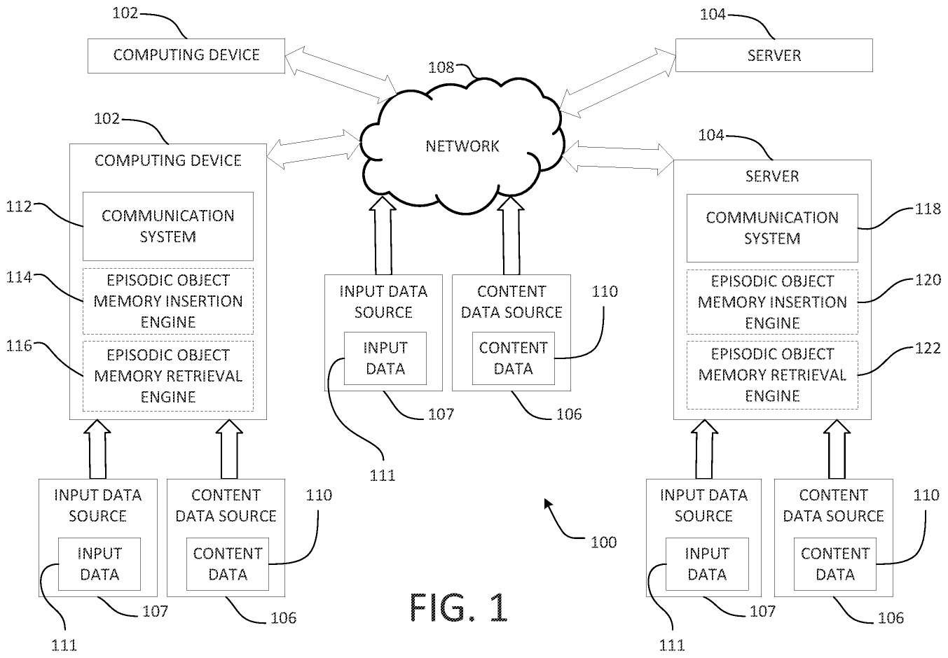

FIG. 1 shows an example of a system 100, in accordance with some aspects of the disclosed subject matter. The system 100 may be a system for storing landmark memories in an episodic object memory. Additionally, or alternatively, the system 100 may be a system for using an episodic object memory, such as by retrieving information from the episodic object memory. The system 100 includes one or more computing devices 102, one or more servers 104, a content data source 106, an input data source 107, and a communication network or network 108.

The computing device 102 can receive content data 110 from the content data source 106, which may be, for example a microphone, a camera, a global positioning system (GPS), etc. that transmits content data, a computer-executed program that generates content data, and/or memory with data stored therein corresponding to content data. The content data 110 may include visual content data, audio content data (e.g., speech or ambient noise), gaze content data, calendar entries, emails, document data (e.g., a virtual document), weather data, news data, blog data, encyclopedia data and/or other types of virtual and/or real content data that may be recognized by those of ordinary skill in the art. In some examples, the content data may include text, images, source code, commands, skills, and/or programmatic evaluations.

The computing device 102 can further receive input data 111 from the input data source 107, which may be, for example, a camera, a microphone, a computer-executed program that generates input data, and/or memory with data stored therein corresponding to input data. The content data 111 may be, for example, a user-input, such as a voice query, text query, etc., an image, an action performed by a user and/or a device, a computer command, a programmatic evaluation, or some other input data that may be recognized by those of ordinary skill in the art.

Additionally, or alternatively, the network 108 can receive content data 110 from the content data source 106. Additionally, or alternatively, the network 108 can receive input data 111 from the input data source 107.

Computing device 102 may include a communication system 112, an episodic object memory insertion engine or component 114, and/or an episodic object memory retrieval engine or component 116. In some examples, computing device 102 can execute at least a portion of the episodic object memory insertion component 114 to generate collections of embeddings corresponding to one or more subsets of the received content data 110 to be inserted into an episodic object memory. For example, each of the subsets of the content data may be provided to a machine-learning model, such as a natural language processor and/or a visual processor, to generate a collection of embeddings. In some examples, the subsets of content data may be provided to another type of model, such as a generative large language model (LLM).

Further, in some examples, computing device 102 can execute at least a portion of the episodic object memory retrieval component 116 to retrieve one or more landmark memories, or associated information, from an episodic object memory, such as based on input (e.g., generated based on the input data 111). In some examples, the episodic object memory retrieval component 116 can further determine an action. For example, the action may be determined based on the input and one or more embeddings corresponding to a landmark memory (e.g., one or more landmark memory embeddings).

Server 104 may include a communication system 112, an episodic object memory insertion engine or component 114, and/or an episodic object memory retrieval engine or component 116. In some examples, server 104 can execute at least a portion of the episodic object memory insertion component 114 to generate collections of embeddings corresponding to one or more subsets of the received content data 110 to be inserted into an episodic object memory. For example, each of the subsets of the content data may be provided to a machine-learning model, such as a natural language processor and/or a visual processor, to generate a collection of embeddings. In some examples, the subsets of content data may be provided to another type of model, such as a generative large language model (LLM).

Further, in some examples, server 104 can execute at least a portion of the episodic object memory retrieval component 116 to retrieve one or more landmark memories, or associated information, from an episodic object memory, such as based on input (e.g., generated based on the input data 111). In some examples, the episodic object memory retrieval component 116 can further determine an action. For example, the action may be determined based on the input and one or more embeddings corresponding to a landmark memory (e.g., one or more landmark memory embeddings).

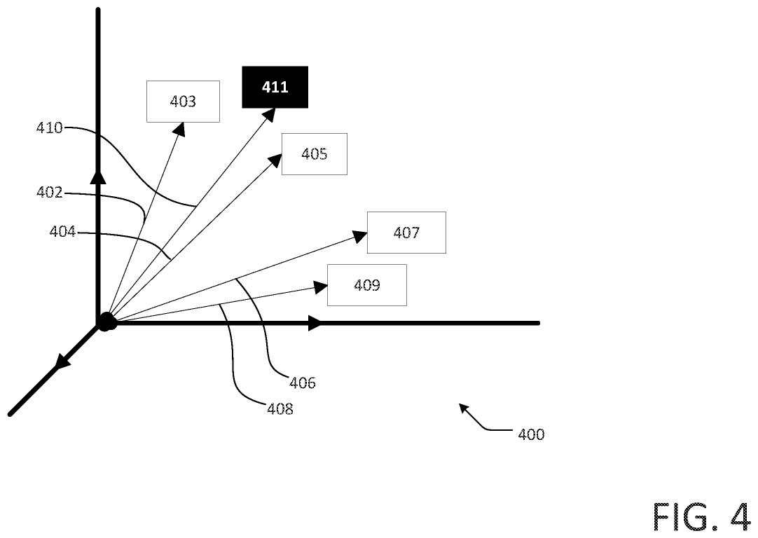

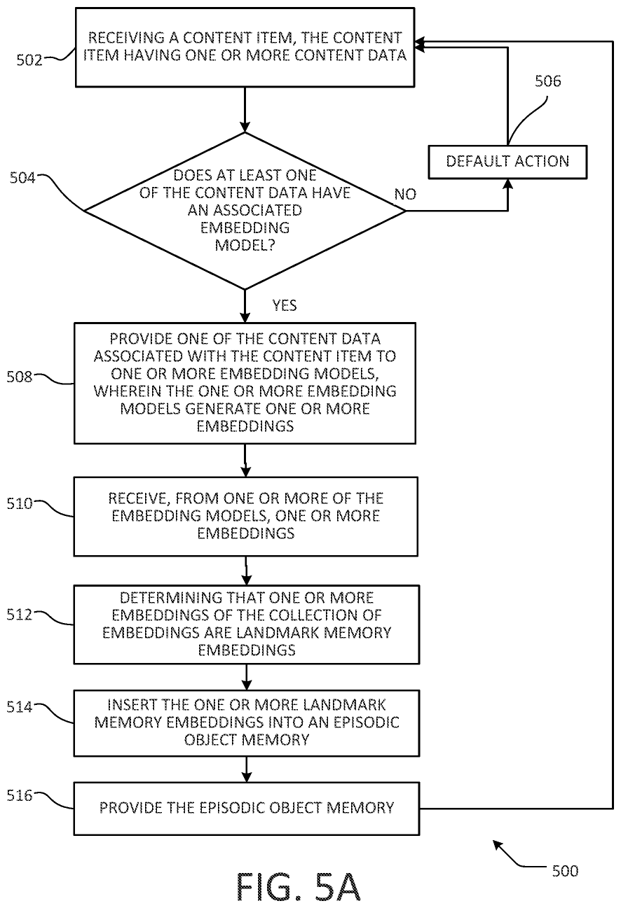

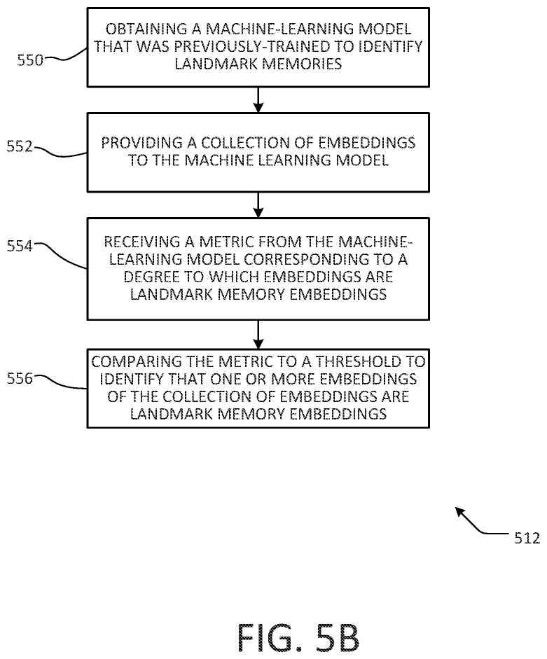

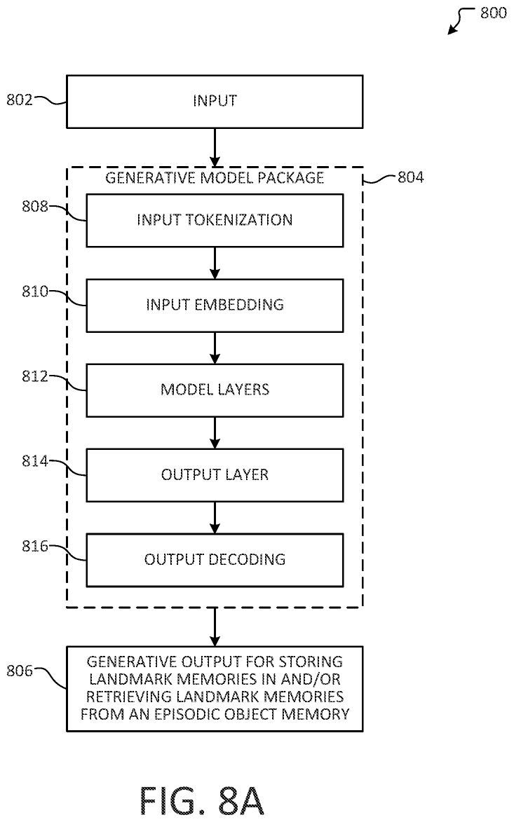

Additionally, or alternatively, in some examples, computing device 102 can communicate data received from content data source 106 and/or input data source 107 to the server 104 over a communication network 108, which can execute at least a portion of the episodic object memory insertion component 114 and/or the episodic object memory retrieval engine 116. In some examples, the episodic object memory insertion component 114 may execute one or more portions of methods/processes 400 and/or 700 described below in connection with FIGS. 4 and 7, respectively. Further in some examples, the episodic object memory retrieval component 116 may execute one or more portions of methods/processes 500 and/or 700 described below in connection with FIGS. 5 and 7, respectively.

In some examples, computing device 102 and/or server 104 can be any suitable computing device or combination of devices, such as a desktop computer, a vehicle computer, a mobile computing device (e.g., a laptop computer, a smartphone, a tablet computer, a wearable computer, etc.), a server computer, a virtual machine being executed by a physical computing device, a web server, etc. Further, in some examples, there may be a plurality of computing device 102 and/or a plurality of servers 104. It should be recognized by those of ordinary skill in the art that content data 110 and/or input data 111 may be received at one or more of the plurality of computing devices 102 and/or one or more of the plurality of servers 104, such that mechanisms described herein can insert entries into an embedding object memory and/or use the embedding object memory, based on an aggregation of content data 110 and/or input data 111 that is received across the computing devices 102 and/or the servers 104.

In some examples, content data source 106 can be any suitable source of content data (e.g., a microphone, a camera, a GPS, a sensor, etc.). In a more particular example, content data source 106 can include memory storing content data (e.g., local memory of computing device 102, local memory of server 104, cloud storage, portable memory connected to computing device 102, portable memory connected to server 104, etc.). In another more particular example, content data source 106 can include an application configured to generate content data. In some examples, content data source 106 can be local to computing device 102. Additionally, or alternatively, content data source 106 can be remote from computing device 102 and can communicate content data 110 to computing device 102 (and/or server 104) via a communication network (e.g., communication network 108).

In some examples, input data source 107 can be any suitable source of input data (e.g., a microphone, a camera, a sensor, etc.). In a more particular example, input data source 107 can include memory storing input data (e.g., local memory of computing device 102, local memory of server 104, cloud storage, portable memory connected to computing device 102, portable memory connected to server 104, privately accessible memory, publicly-accessible memory, etc.). In another more particular example, input data source 107 can include an application configured to generate input data. In some examples, input data source 107 can be local to computing device 102. Additionally, or alternatively, input data source 107 can be remote from computing device 102 and can communicate input data 111 to computing device 102 (and/or server 104) via a communication network (e.g., communication network 108).

In some examples, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, communication network 108 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

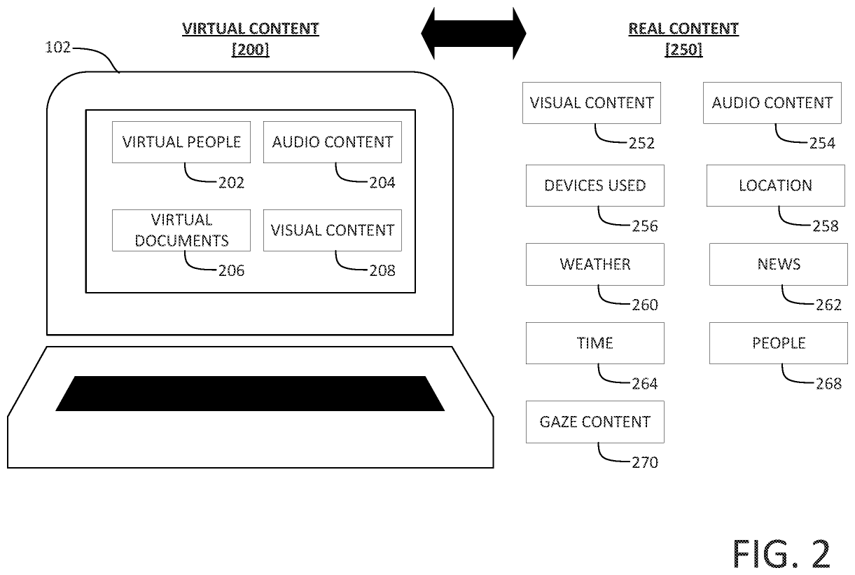

FIG. 2 illustrates examples of virtual content 200 and real content 250, according to some aspects described herein. As discussed with respect to system 100, mechanisms described herein may include receiving content data (e.g., content data 110) from a content data source. The content data may be virtual content 200 and/or real content 250.

Generally, when a user is interacting with a computing device (e.g., computing device 102), they are interacting with a virtual environment, while physically in a real (e.g., physical environment). Therefore, contextual information that a user may recall when interacting with computing device may be virtual content (e.g., virtual content 200) and/or real content (e.g., real content 250).

The virtual content 200 includes virtual people 202, audio content 204, virtual document 206, and/or visual content 208. The virtual people 202 may include data corresponding to virtual images that are generated of individuals, such as via a video stream, still images, virtual avatars corresponding to people, etc. Additionally, or alternatively, the virtual people 202 may include data corresponding to people, such as icons corresponding to people, or other indicators corresponding to specific people that may be recognized by those of ordinary skill in the art.

The audio content 204 may include data corresponding to speech data that is generated in a virtual environment. For example, the audio content 204, in a virtual environment, may be generated by the computing device 102 to correspond to audio that is received from a user (e.g., where the user is speaking into a microphone a computing device that may be separate from the computing device 102). Additionally, or alternatively, the audio content 204 may correspond to other types of audio data that may be generated in a virtual environment, such as animal sounds, beeps, buzzes, or another type of audio indicator.

The virtual documents 206 may include a type of document that is found in a virtual environment. For example, the virtual document 206 may be a text-editing document, a presentation, an image, a spreadsheet, an animated series of images, a calendar invite, an email, a notification, or any other type of virtual document that may be recognized by those of ordinary skill in the art.

The visual content 208 may include data corresponding to graphical content that may be displayed or generated by a computing device. For example, the visual content 208 may be content that is generated via an application being run on the computing device 102 (e.g., a web-browser, a presentation application, a teleconferencing application, a business management application, etc.). The visual content 208 may include data that is scraped from a screen display of the computing device 102. For example, any visual indication that is displayed on the computing device 102 may be included in the visual content 208.

Each of the plurality of types of virtual content 200 may be subsets of the virtual content 200 that may be received by mechanisms described herein, as a subset of the content data 110. Further, while specific examples of types of virtual content have been discussed above, additional and/or alternative types of virtual content may be recognized by those of ordinary skill in the art as they relate to virtual environments and/or a virtual component of augmented reality environment.

The real content 250 includes visual content 252, audio content 254, devices used 256, location 258, weather 260, news 262, time 264, people 268, and/or gaze content 270. The visual content 252 may include data that is received from a camera or optical sensor. For example, the visual content 252 may include information regarding a user's biometric data, that is collected with a user's permission, or information regarding a user's physical environment, or information regarding clothing that a user is wearing, etc. Additional examples of visual content 252 may be recognized by those of ordinary skill in the art.

The audio content 254 includes audio data that originates from a real or physical environment. For example, the audio content 254 may include data corresponding to speech data (e.g., audio that is spoken by a user or audio that can otherwise be converted into text associated with speech). Additionally, or alternatively, the audio content 204 may include data corresponding to ambient noise data. For example, the audio content 204 may include animal sounds (e.g., a dog barking, a cat meowing, etc.), traffic sounds (e.g., airplanes, cars, sirens, etc.), nature sounds (e.g., waves, wind, etc.). Additional examples of audio content 254 may be recognized by those of ordinary skill in the art.

The devices used 256 may include information regarding which device a user is using. For example, when a user is trying to locate a virtual document (e.g., virtual document 206), they may remember last accessing the virtual document on a first computing device (e.g., a mobile phone), as compared to a second computing device (e.g., a laptop). Therefore, based on a user's memory that associates a specific device, with an element (e.g., virtual document or computer application) that is trying to be accessed or discovered, mechanisms disclosed herein can locate or open the desired element that is trying to be accessed or discovered.

The location 258 may include information regarding a location at which a user is located. For example, location data may be received from a global positioning system (GPS), satellite positing system, cellular positioning system, or other type of location determining system. A user may associate a location in which they were physically located with actions that were performed on a computing device. Therefore, for example, using mechanisms disclosed herein, a user may provide a query such as “what document was I working on, while I as at the beach, and videoconferencing my boss?”, and mechanisms disclosed herein may determine one or more documents to which the user may be referring, based on information that is stored regarding which document they were working on, when they were at the beach, as well as when they were videoconferencing with their boss.

The weather 260 may include information regarding weather that is around a user. For example, for a given time, as determined by the time content 264, weather information (e.g., precipitation, temperature, humidity, etc.) may be received or otherwise obtained for where a user is located (e.g., based on the location content 258). Therefore, for example, using mechanisms disclosed herein, a user may provide a query such as “who was I on a video call with, on my cell phone, when it was freezing and snowing outside?” Mechanisms disclosed herein may determine what virtual person (e.g., from the virtual people content 202) the user is trying to recall, based on when the user's cell phone (e.g., from the devices used content 256) was used, and on when it was freezing and snowing outside (e.g., from the weather content 260).

The news 262 may include information regarding recent news stories of which a user may be aware. For example, for a given time, as determined by the time content 264, a relatively recent news story covering a significant event may have been released. Therefore, for example, using mechanisms disclosed herein, a user may provide a query such as “who was I on a video call with, on my laptop, on the day when Chicago's basketball team won the national championships?” Mechanisms disclosed herein may determine what virtual person (e.g., from the virtual people content 202) the user is trying to recall, based on when the user's laptop (e.g., from the devices used content 256) was used, and on when Chicago's basketball team won the national championships (e.g., from the news content 262). Additional or alternative types of news stories may include holidays, birthdays, local events, national events, natural disasters, celebrity updates, scientific discoveries, sports updates, or any other type of news that may be recognized by those of ordinary skill in the art.

The time 264 may include one or more timestamps at which various content types are received. For example, each content types (e.g., virtual content 200 and/or real content 250, or specific content types therewithin) may be timestamped, when they are obtained or received. Generally, mechanisms described herein may be temporal, in that actions that are performed by computing devices, based on a plurality of stored content types, may rely on timestamps assigned to each of the content types.

The people 268 may include information regarding people in a physical environment surrounding one or more computing devices (e.g., computing device 102). The people may be identified using biometric recognition (e.g., facial recognition, voice recognition, fingerprint recognition, etc.), after receiving and storing any related biometric data, with a user's permission. Additionally, or alternatively, the people may be identified by engaging performing a specific action on the computing device (e.g., engaging with a specific software). Further, some people may be identified by logging into one or more computing devices. For example, a person may be the owner of the computing device, and the computing device may be linked to the person (e.g., via a passcode, biometric entry, etc.). Therefore, when the computing device is logged into, the person is thereby identified. Similarly, a person may be identified by logging into a specific application (e.g., via a passcode, biometric entry, etc.). Therefore, when the specific application is logged into, the person is thereby identified. Additionally, or alternatively, the one or more people may be identified using a radio frequency identification tag (RFID), an ID badge, a bar code, a QR code, or some other means of identification that is capable of identifying a person via some technological interface. Additionally, or alternatively, a proximity of certain people with respect to one another may be identified based on two or more people being identified using mechanisms described herein.

The gaze content 270 may include information corresponding to where a user is looking on one or more computing devices. Accordingly, if a first user is on a videoconference call and tells a second user that they will send the second user a document that they discussed, while looking at the document on their computing device, then mechanisms described herein may generate a draft email to send the draft document, from the first user, to the second user, based on the audio content received from the videoconference call, the gaze content received, and recognition of who the second user is, such that the email is drafted to be sent to the current person. Similarly, the draft document may be saved to a user's clipboard, such that the draft document can be pasted into an email, message, or other form of virtual communication.

Additional types of virtual content 200 and/or real content 250 may be recognized by those of ordinary skill in the art. Further, while certain content types have been shown and described to be types of virtual content 200 (e.g., virtual people 202, audio content 204, virtual documents 206, and visual content 208), while other content types have been shown and described to be real content (e.g., visual content 252, audio content 254, devices used 256, location 258, weather 260, news 262, time 264, people 268, and gaze content 270) it should be recognized that in some examples, such categorizations of virtual content 200 and real content 250 can be interchanged for content types disclosed herein (e.g., when a location may refer to a virtual location, such as a virtual meeting space, as well as a physical location at which a device that is being used, to access the virtual meeting space, is located), whereas in other instances, such categorization of virtual content 200 and real content 250 are fixed (e.g., in example where a location refers solely to a physical location, such as a geographic coordinate location in the physical world).

Generally, the different content types discussed with respect to FIG. 2 provide various contexts with which a user associates information that they are trying to recall and/or use to perform an action, via computing device. In some examples, a user may provide real content (e.g., real content 250) information to receive information from a computing device, or perform an action on a computing device, related to virtual content (e.g., virtual content 200). Additionally, or alternatively, a user may provide virtual content (e.g., virtual content 200) information to receive information from a computing device related to real or physical content (e.g., real content 250). Additionally, or alternatively, a user may provide a combination of virtual and real content to receive information corresponding to related real content, receive information corresponding to virtual content, and/or to perform an action, via a computing device, related to the virtual content.

One of ordinary skill in the art will recognize the various contexts in which the examples of virtual content 200 and real content 250 may be collected. For example, the content 200, 250 may be collected for business operations, coaching histories, medical experiences, project management, event planning and execution. For example, in healthcare, landmark memories can correspond to content encoded based on landmark medical experiences, events, and/or content over time (e.g., starts of key illnesses, salient tests and lab results, diagnoses, hospitalizations, surgeries, visits to doctors, family health challenges, etc.). These landmark medical items may be stored as landmark memories using mechanisms provided herein and leveraged in interactions to ground a physician or patient with an artificially-intelligent (AI) system, such as which incorporates aspects of systems provided herein.

Generally, users may be more likely to remember atypia content information than regular content information. Therefore, atypia data may be determined to be associated with a landmark memory, using mechanisms described herein. Atypia data is data that is irregular or abnormal given a category in which the data may be categorized. For example, a piece of data that occurs less than 1% of a time within a category of data in which the piece of data may be categorized, such as a category for people, events, locations, etc., may be determined to be atypia data. In alternative examples, the 1% threshold may be 5%, or 10%, or 20%, or any values or range of values therebetween.

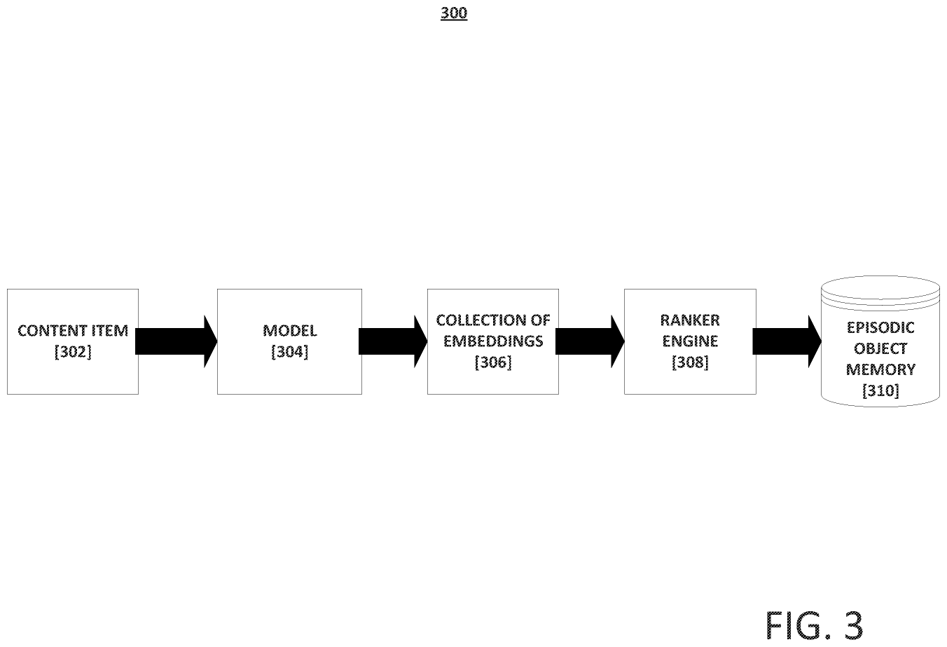

FIG. 3 illustrates an example flow 300 of storing entries in an episodic object memory. The example flow begins with content item 302 being received. The content item 302 may be received from a content data source, such as the content data source 110 described earlier herein with respect to FIG. 1. Further, content item 302 may include virtual content and/or real content, such the virtual content 200 and/or the real content 250 described earlier herein with respect to FIG. 2. The content item 302 may be one or more content items or objects that each include one or more content data.

Content data of the content item 302 may be input into a model 304. For example, the model 304 may include a machine-learning model, such as a machine-learning model that is trained to generate one or more embeddings, based on received content data. In some examples, the model 304 includes a generative model, such as a generative large language model (LLM). In some examples, the model 304 includes a natural language processor. Additionally, or alternatively, in some examples, the model 304 includes a visual processor. The model 304 may be trained on one or more datasets that are compiled by individuals and/or systems. Additionally, or alternatively, the model 304 may be trained based on a dataset that includes information obtained from the Internet. Further, the model 304 may include a version. One of skill in the art will appreciate that any type of model may be employed as part of the aspects disclosed herein without departing from the scope of this disclosure.

The model 304 may output a collection of embeddings 306. The collection of embeddings 306 may include one or more embeddings (e.g., one or more semantic embeddings). The collection of embeddings 306 may be unique to the model 304. Additionally, or alternatively, the collection of embeddings 306 may be unique to the specific version of the model 304. Each embedding in the collection of embeddings 306 may correspond to a respective content object and/or respective content data from the content item 302. Therefore, for each object and/or content data in the content item 302, the model 304 may generate an embedding.

Each of the embeddings in the collection of embeddings 306 may be associated with a respective indication (e.g., byte address) corresponding to a location of source data associated with the embeddings. For example, if the content item 302 corresponds to a set of emails, then the collection of embeddings 306 may be hash values generated for each of the emails based on the content within the emails (e.g., abstract meaning of words or images included in the email). An indication corresponding to the location of an email (e.g., in memory) may then be associated with the embedding generated based off of the email. In this respect, the actual source data of a content object may be stored separately from the corresponding embedding that may occupy less memory. While a specific example where the content item 302 corresponds to a set of emails, additional and/or alternative examples will be recognized by those of ordinary skill in the art, at least in light of teachings provided herein.

The embeddings 306 may be provided to a ranker engine 308. The ranker engine 308 may rank, score, and/or assign weights to one or more of the embeddings 306. The ranking and/or weighting may be based on a dissimilarity of one or more of the embeddings from the collection of embeddings 306 to one or more of the other embeddings from the collection of embeddings 306. One or more of the ranked, scored, and/or weighted embeddings may correspond to landmark memories. The one or more of the ranked, scored, and/or weighted embeddings that correspond to landmark memories may be determined to be landmark memory embeddings.

Generally, users may be more likely to remember atypia content information than regular content information. Therefore, atypia data may be determined to be associated with and/or labelled as a landmark memory, using mechanisms described herein. Based on determining a landmark memory, data that is related to the landmark memory (e.g., related by time, location, person, etc.) can then also be determined, such that the landmark memory may be a pivot point for searching data related thereto. Atypia data is data that is irregular or abnormal. For example, a piece of data that occurs less than 1% of a time within a category of data in which the piece of data may be categorized, such as a person, event, location, email, etc., may be determined to be atypia data. In some examples, the 1% threshold may instead be 5%, or 10%, or 20%, or any values or range of values therebetween.

The one or more embeddings that are ranked, scored, and/or weighted (e.g., with respect to a degree to which they are landmark memory embeddings), may be inserted into the episodic object memory 310. Additionally, or alternatively, a subset of the ranked, scored, and/or weighted embeddings may be inserted into the episodic object memory 310 based on comparing the ranking, scoring, and/or weighting thereof to a predetermined threshold, thereby determining which of the embeddings are landmark memory embeddings. The one or more landmark memory embeddings may be stored in the episodic object memory 310 with an indication of the corresponding ranking, score, and/or weighting. Further, the landmark memory embeddings may be associated with a reference (e.g., a pointer) to related data associated with the one or more landmark memory embeddings (e.g., embeddings that are similar to the landmark memory embeddings, source data associated with the landmark memory embeddings). The landmark memories described herein may include a set of properties that define a schema. The set of properties may include a summary of the landmark memory (e.g., a natural language summary of the landmark memory) and/or the reference (e.g., pointer) to data related to the landmark memories.

In some examples, the episodic object memory 310 stores only landmark memory embeddings. Additionally, or alternatively, in some examples, the episodic object memory 310 stores embeddings that are landmark memory embeddings and embeddings that are not landmark memory embeddings, such as with an indication corresponding to which embeddings are landmark memory embeddings and which embeddings are not landmark memory embeddings.

FIG. 4 illustrates an example vector space 400 according to some aspects described herein. The vector space 400 includes a plurality of feature vectors, such as a first feature vector 402, a second feature vector 404, a third feature vector 406, a fourth feature vector 408, and a fifth feature vector 410. Each of the plurality of feature vectors 402, 404, 406, and 408 correspond to a respective embedding 403, 405, 407, 409 generated based on a plurality of subsets of content data (e.g., subsets of content data 110, virtual content 200, and/or real content 250). The embeddings 403, 405, 407, and 409 may be semantic embeddings. The fifth feature vector 410 is generated based on an input embedding 411 (e.g., an embedding being ranked or weighted against the other embeddings). The input embeddings may also be generated based on the content data. Alternatively, the input embedding may be provided separately (e.g., based on user-input).

The feature vectors 402, 404, 406, 408, 410 each have distances that are measurable between each other. For example, a distance between the feature vectors 402, 404, 406, and 408 and the fifth feature vector 410 corresponding to the input embedding 411 may be measured using cosine similarity. Alternatively, a distance between the feature vectors 402, 404, 406, 408 and the fifth feature vector 410 may be measured using another distance measuring technique (e.g., an n-dimensional distance function) that may be recognized by those of ordinary skill in the art.

A similarity of each of the feature vectors 402, 404, 406, 408 to the feature vector 410 corresponding to the input embedding 411 may be determined, for example based on the measured distances between the feature vectors 402, 404, 406, 408 and the feature vector 410. The similarity between the feature vectors 402, 404, 406, 408 and the feature vector 410 may be used to rank, weight, group, or cluster the feature vectors 402, 404, 406, and 408 (e.g., based on how dissimilar one vector is to the others).

The embeddings 403 and 405 that correspond to feature vectors 402 and 404, respectively, may fall within the same content group. For example, the embedding 403 may be related to a first email, and the embedding 405 may be related to a second email. Additional and/or alternative examples of content groups in which the embeddings may be categorized may be recognized by those of ordinary skill in the art.

Examples clusters of embeddings, such as including one or more embeddings selected from the embeddings 403, 405, 407, 409, and 411, may be clusters of embeddings that correspond to a person, geographic location, image, and/or other modalities, such as smell, haptics, etc. In some examples, embeddings described herein include sentiment (e.g., of photos, videos, etc.), cognitive states, or the like. Meta-information may be established about content that corresponds to embeddings disclosed herein. For example, the meta-information may include patterns of output, a number of queries from a user, etc. In some examples, embeddings may be filtered based on salience of memories to which the embeddings correspond. Accordingly, an importance or prominence of one or more embeddings may be determined using mechanisms provided herein based on memories to which the one or more embeddings correspond.

One or more of the embeddings 403, 405, 407, 409, and 411 may be stored in a data structure, such as an ANN tree, a k-d tree, an octree, another n-dimensional tree, or another data structure that may be recognized by those of ordinary skill in the art that is capable of storing vector space representations. Further, memory corresponding to the data structure in which the one or more of the embeddings 403, 405, 407, 409, and 11 are stored may be arranged or stored in a manner that groups the embeddings together, within the data structure, such as to improve efficiency for subsequent search processes.

In some examples, feature vectors and their corresponding embeddings generated in accordance with mechanisms described herein may be stored for an indefinite period of time. Additionally, or alternatively, in some examples, as new feature vectors and/or embeddings are generated and stored, the new feature vectors and/or embeddings may overwrite older feature vectors and/or embeddings that are stored in memory (e.g., based on metadata of the embeddings indicating a version), such as to improve memory capacity. Additionally, or alternatively, in some examples, feature vectors and/or embeddings may be deleted from memory at specified intervals of time, and/or based on an amount of memory that is available (e.g., in the embedding object memory 310), to improve memory capacity.

Generally, the ability to store embeddings corresponding to received content data allows a user to associate and locate data in a novel manner that has the benefit of being computationally efficient. For example, instead of storing a video recording of a screen of a computing device, or web pages on the Internet, a user may instead store, using mechanisms described herein, embeddings corresponding to content objects. The embeddings may be hashes, as opposed to, for example, video recordings that may be a few hundreds of thousands of pixels, per frame. Therefore, the mechanisms described herein are efficiency for reducing memory usage, as well as for reducing usage of processing resources to search through stored content. Additional and/or alternative advantages may be recognized by those of ordinary skill in the art.

FIG. 5A illustrates an example method 500 for storing a landmark memory (e.g., a landmark memory embedding and/or landmark memory text) in an episodic object memory, according to some aspects described herein. In examples, aspects of method 500 are performed by a device, such as computing device 102 and/or server 104, discussed above with respect to FIG. 1.

Method 500 begins at operation 502 wherein one or more content items or objects are received. The content items may have one or more content data. The one or more content data may include at least one real content data and/or at least one virtual content data. The content data may be similar to the content data 110 discussed with respect to FIG. 1. Additionally, or alternatively, the content data may be similar to the virtual content data 200 and/or real content data 250 discussed with respect to FIG. 2.

The content data may include one or more of audio content data, visual content data, gaze content data, calendar content data, email content data, virtual documents, data generated by specific software applications, weather content data, news content data, encyclopedia content data, location content data, and/or blog content data. In some examples, the content data may include at least one of a skill, command, or programmatic evaluation. Additional and/or alternative types of content data may be recognized by those of ordinary skill in the art.

At operation 504, it is determined if at least one of the subsets of content data has an associated embedding model (e.g., semantic embedding model). For example, the embedding model may be similar to the model 304 discussed with respect to FIG. 3. The embedding model may be trained to generate one or more embeddings, based on the at least one of the subsets of content data. In some examples, the embedding model may include a natural language processor. In some examples, the embedding model may include a visual processor. In some examples, the embedding model may include a machine-learning model. Still further, in some examples, the embedding model may include a generative large language model. The embedding model may be trained on one or more datasets that are compiled by individuals and/or systems. Additionally, or alternatively, the embedding model may be trained based on a dataset that includes information obtained from the Internet.

If it is determined that at least one of the content data does not have an associated embedding model, flow branches “NO” to operation 506, where a default action is performed. For example, the content data and/or content items may have an associated pre-configured action.

In other examples, method 500 may comprise determining whether the content data and/or content items have an associated default action, such that, in some instances, no action may be performed as a result of the received content items. Method 500 may terminate at operation 506. Alternatively, method 500 may return to operation 502 to provide an iterative loop of receiving one or more content items and determining if at least one of the content data of the content items have an associated embedding model.

If however, it is determined that at least one of the content data have an embedding model, flow instead branches “YES” to operation 508, where, one of the content data associated with the content item are provided to one or more embedding models. The embedding models generate one or more embeddings. Further, the one or more embedding models may include a version. Each of the embeddings generated by the respective embedding model may include metadata corresponding to the version of the embedding model that generated the embedding.

In some examples, the content data is provided to the one or more embedding models locally. In some examples, the content data is provided to the one or more embedding model via an application programming interface (API). For example, a first device (e.g., computing device 102 and/or server 104) may interface with a second device (e.g., computing device 102 and/or server 104) via an API that is configured to provide embeddings or indications thereof, in response to receiving content data or indications thereof.

At operation 510, one or more embeddings are received from one or more of the embedding models. In some examples, the one or more embeddings are a collection or plurality of embeddings. For example, a collection of embeddings (such as the collection of embeddings 306) may be associated with a first embedding model (e.g., the model 304). In some examples, the collection of embeddings may be uniquely associated with the first embedding model, such that a second embedding model generates a different collection of embeddings than the first embedding model. Further, in some examples, the collection of embeddings may be uniquely associated with the version of the first embedding model, such that a different version of the first embedding model generates a different collection of embeddings.

The collection of embeddings may include an embedding generated by the first embedding model for at least one content data of a plurality of content data. For example, the content data may correspond to an email, an audio file, a message, a website page, etc. Additional and/or alternative types of content objects or items that correspond to the content data may be recognized by those of ordinary skill in the art.

At operation 512, one or more of the embeddings of the collection of embeddings are determined to be landmark memory embeddings. In some examples, one or more of the embeddings are ranked, weighted, and/or scored to determine whether they are landmark memory embeddings. The ranking, weighting, and/or scoring may be based on a dissimilarity to at least one of the other embeddings of the collection of embeddings. In some examples, the dissimilarity may be calculated based on distance formulas (e.g., in a vector space, such as the vector space 400), text comparisons, visual comparisons, and/or other comparison techniques that may be recognized by those of ordinary skill in the art.

In some examples, the determining at operation 512 includes obtaining a machine-learning model that was previously-trained to identify landmark memories. The collection of embeddings may be provided to the machine-learning model. A score may be received from the machine-learning model that corresponds to a degree to which embeddings are landmark memory embeddings. The score may be used to rank and/or weight the embeddings (e.g., using mechanism described herein). Additionally, or alternatively, the score may be compared to a threshold to identify that one or more embeddings of the collection of embeddings are landmark memory embeddings.

Generally, users may be more likely to remember atypia content information than regular content information. Therefore, embeddings generated based on atypia data may be determined to be and/or labelled as a landmark memory embedding, using mechanisms described herein. Based on determining a landmark embedding memory, data that is related to the landmark embedding memory (e.g., based on time, location, person, or other content data corresponding to the landmark embedding memory) can then also be determined, such that the landmark memory embedding may be a pivot point for searching data related thereto. Atypia data is data that is irregular or abnormal. For example, a piece of data that occurs less than 1% of a time within a category of data in which the piece of data may be categorized, such as a person, event, location, email, etc., may be determined to be atypia data. In some examples, the 1% threshold may instead be 5%, or 10%, or 20%, or any values or range of values therebetween.

Some examples include receiving input (e.g., user-input) that corresponds to a degree or threshold of episodic memory. The input may be received from any of a variety of inputs, such as a button, a gaze input, a vocal input, a text input, a gesture input, a touchpad, a mouse, a slider, etc. Further, the user-input may be received from a graphical user-interface. In some examples, the rankings, weighting, and/or score of the embeddings may be compared to the threshold of episodic memory to determine which of one or more embeddings from a collection of embeddings are landmark memory embeddings. For examples, if the ranking of a specific embedding is higher than the threshold of episodic memory, then the specific embedding may be a landmark memory embedding. Alternatively, in some examples, if the ranking of a specific embedding is lower than the degree of episodic memory, then the specific embedding may be a landmark memory embedding. Additional and/or alternative examples for comparing metrics of landmark memory embeddings to a threshold may be recognized by those of ordinary skill in the art.

At operation 514, the one or more landmark memory embeddings are inserted into the episodic object memory. In some examples, the episodic object memory may be an index, or a database, or a tree (e.g., ANN tree, k-d tree, etc.), or another type of memory that may be recognized by those of ordinary skill in the art. The episodic object memory includes one or more embeddings (e.g., landmark memory embeddings) from the collection of embeddings. Further, the one or more embeddings may be associated with a respective indication that corresponds to a location of source data associated with the one or more embeddings. The source data can include one or more of audio files, text files, image files, video files, and/or website pages. Additional and/or alternative types of source data may be recognized by those of ordinary skill in the art. The embeddings may occupy relatively little memory. For example, each embedding may be a 64-bit hash. Comparatively, the source data may occupy a relatively large amount of memory. Accordingly, by storing an indication to the location of the source data in the embedding object memory, as opposed to the raw source data, mechanisms described herein may be relatively efficient for memory usage of one or more computing devices.

The indications that corresponds to a location of source data may be byte addresses, uniform resource indicators (e.g., uniform resource links), or another form of data that is capable of identifying a location of source data. Further, the episodic object memory may be stored at a location that is different than the location of the source data. Additionally, or alternatively, the source data may be stored in memory of a computing device or server on which the episodic object memory (e.g., episodic object memory 310) is located. Additionally, or alternatively, the source data may be stored in memory that is remote from a computing device or server on which the episodic object memory is located.

In some examples a subset of the ranked embeddings may be inserted into the episodic object memory based on comparing the ranking (or weighting) thereof to a predetermined threshold. The one or more ranked embeddings may be stored in the episodic object memory with an indication of the corresponding ranking (or weighting). Further, the ranked embeddings may be associated with a reference (e.g., a pointer) to related data associated with the one or more ranked embeddings (e.g., embeddings that are similar to the ranked embeddings, source data associated with the ranked embeddings). The landmark memory embeddings described herein may include a set of properties that define a schema. The set of properties may include a summary of the landmark memory embedding (e.g., a natural language summary of the landmark) and/or the reference (e.g., pointer) to data related to the landmark memory embedding.

In some examples, the episodic object memory stores only landmark memory embeddings. Additionally, or alternatively, in some examples, the episodic object memory stores embeddings that are landmark memory embeddings and embeddings that are not landmark memory embeddings, such as with an indication corresponding to which embeddings are landmark memory embeddings and which are not landmark memory embeddings.

In some examples, the insertion at operation 514 triggers a spatial storage operation to store a vector representation of the one or more landmark memory embeddings. The vector representation may be stored in a data structure, such as an ANN tree, a k-d treen, an n-dimensional tree, an octree, or another data structure that may be recognized by those of ordinary skill in the art in light of teachings described herein. Additional and/or alternative types of storage mechanisms that are capable of storing vector space representations may be recognized by those of ordinary skill in the art.

At operation 514, the episodic object memory is provided. For example, the episodic object memory may be provided as an output for further processing to occur. In some examples, the episodic object memory may be used to retrieve information and/or generate an action, as will be described in some examples in further detail herein.

Generally, embeddings may be used as quantitative representations of abstract meaning that is discerned from content data. Accordingly, different embedding models may generate different embeddings for the same received content data, such as depending on how the embedding models are trained (e.g., based on different data sets and/or training methods) or otherwise configured. In some examples, some embedding models may be trained to provide relatively broader interpretations of received content than other embedding models that are trained to provide relatively narrower interpretations of content data. Accordingly, such embedding models may generate different embeddings.

Method 500 may terminate at operation 516. Alternatively, method 400 may return to operation 502 (or any other operation from method 500) to provide an iterative loop, such as of receiving one or more content items and inserting one or more landmark memory embeddings into an episodic object memory based thereon.

Operations provided in method 500 provide the ability to selectively formulate, store, and later retrieve (see, for example, method 700 discussed with respect to FIG. 7) landmark memories, drawn from a plurality of experienced content, as a means for providing people and machines with efficient options (given limited storage and processing abilities of cognitive systems-human or machine) for storing and then having powerful handles or indices that enable bounded reasoning and recollection systems to perform efficient context-sensitive retrieval of the relevant content, for real-time use (e.g., to maximize the success of people or machines). Such mechanisms may be especially important for cognitive systems (whether people or machines) that continue to amass and leverage experiences in a continuing, lifelong manner of engagements with the complex world.

FIG. 5B illustrates a detailed example of operation 512 according to some aspects described herein. For example, the detailed example of operation 512 may be a method for determining that one or more embeddings of a collection of embeddings are landmark memory embeddings. While operations 550, 552, 554, and 556 described below are discussed as sub-operation to operation 512 of method 500, it should be recognized by those of ordinary skill in the art that the operations 550, 552, 554, and/or 556 may be performed independent of method 500 and/or in cooperation with methods other than method 500.

At operation 550, a machine-learning model is obtained that was previously-trained to identify landmark memories. For example, the machine-learning model may be trained based on a dataset of embeddings and metrics corresponding to a degree to which specific embeddings from the dataset of embeddings are landmark memories.

At operation 552, a collection of embeddings are provided to the machine-learning model. The collection of embeddings may include the embeddings received at operation 510 of FIG. 5A, additionally, or alternatively, the collection of embeddings may be a collection of embeddings that are otherwise received using mechanisms that may be recognized by those of ordinary skill in the art.

At operation 554, a metric is received from the machine-learning model. The metric corresponds to a degree to which one or more embeddings from the collection of embeddings are landmark memory embeddings. The metric may be a score, weight, and/or ranking for each of the one or more embeddings.

At operation 556, the metric may be compared to a threshold to identify that one or more embeddings of the collection of embeddings are landmark memory embeddings. For example, the threshold may be a threshold that is provided via user-input and/or otherwise pre-configured. In some examples, the metric must be greater than the threshold. In some examples, the metric must be less than the threshold. In some examples, the metric must be equal to the threshold. Combinations of equality limitations may be recognized by those of ordinary skill in the art to be used when comparing the metric to a threshold to identify that one or more embeddings of the collection of embeddings are landmark memory embeddings. In some examples, further processing may be performed on the metric, such that a derivative of the metric is used to identify that one or more embeddings of the collection of embeddings are landmark memory embeddings.

Identifying, storing, and manipulating landmark memories that correspond to experiences, learnings, and/or other content may be particularly important for efficient grounding of references to shared experiences when two or more agents (such as a human and a supportive AI system) are working together over time. In extended duration or lifelong agents that are coordinating or communicating over time on projects, there may need to be efficient mechanisms for storing, recognizing, jointly referring to, and/or retrieving experiences, learnings, and/or other content amassed over the course of continuing, long-term (e.g., life-long) engagements in the complex world. Examples of content to which landmark memories may correspond are discussed earlier herein with respect to FIG. 2.

As an example, humans may assume when they work with AI systems, just as they assume when they work with human collaborators, that they can refer, with efficiency of communication with the machine, to events that the humans have naturally encoded and retrieved as landmark memories in episodic memories. To do this well, machines may have representations of the nature of how humans encode landmark memories so that there can be joint reference and/or grounding from a machine to a human and/or a human to a machine. Thus, part of seeking mutual grounding between machines and people in long-term, effective collaborations may be for machines to learn to understand and encode landmark memories in a way that humans encode them (e.g., in the episodic object memory 310). This understanding may enable more deeply-grounded dialog and problem-solving in long-term human-AI collaborative settings, particularly where AI systems are dedicated to supporting specific users and may go through life sharing sensing, problem-solving, and, more generally, life experiences with the specific users.

Operation 512 may terminate at operation 556. Alternatively, operation 512 may continue from operation 556 to operation 514, such than an episodic object memory can be updated based on the determination of operation 512. In some examples, operation 512 may continue from operation 556 to a different method and/or process that may be recognized by those of ordinary skill in the art, at least in light of teachings provided herein.

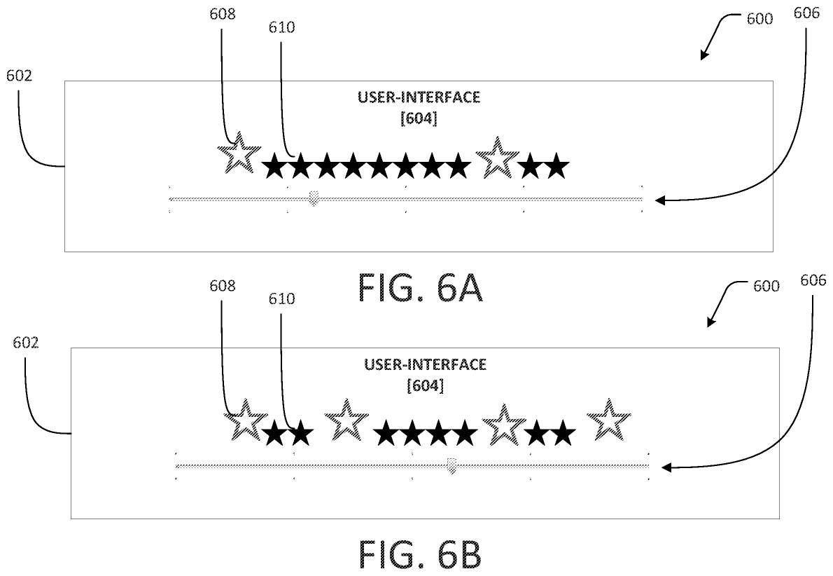

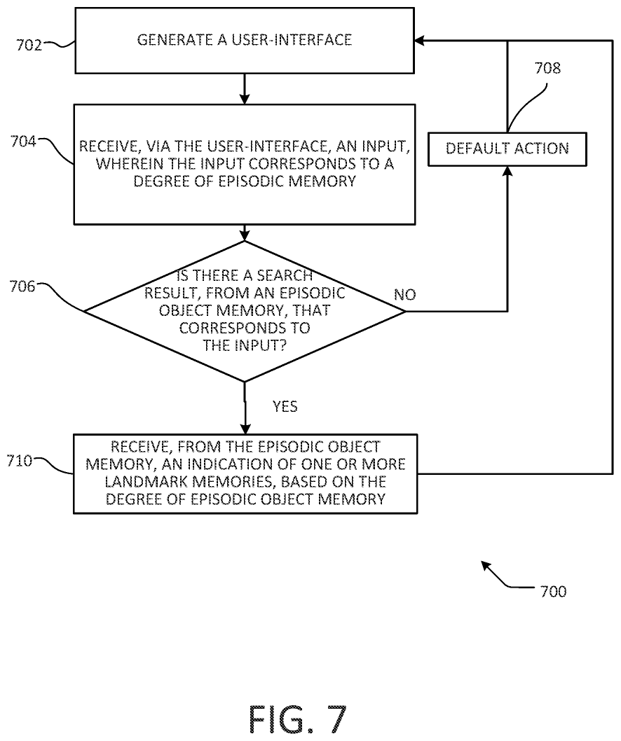

FIGS. 6A and 6B illustrates an example system 600 for retrieving information from an episodic object memory. The example system 600 incudes computing device 602. The computing device 602 may be similar to the computing device 102 described earlier herein with respect to FIG. 1. The system 600 further includes a user-interface 604. The user-interface 604 may be a graphical user-interface (GUI) that is displayed on a screen of the computing device 602. The user-interface 604 may be configured to receive an input from a user.

For example, the GUI 604 includes a slider 606 that may be adjusted based on user input. The input may correspond to a degree or threshold of episodic memory. For example, in FIG. 6A the slider 606 is shown at a first position that corresponds to a first degree or threshold of episodic memory. Comparatively, in FIG. 6B, the slider is shown at a second position that corresponds to a second degree or threshold of episodic memory.

At the first degree of episodic memory, shown in FIG. 6A, one or more first indications 608 of one or more landmark memories may be received (e.g., based on the first degree of episodic memory). In some examples, one or more second indications 610 of stored data that does not correspond to landmark memories may also be received. The one or more first indication 608 and/or one or more second indications 610 may be presented (e.g., on a display screen of a computing device). In some examples, the one or more first indication 608 and/or one or more second indications 610 may be symbols, text, images, audio, and/or representations associated with the data to which the indications 608, 610 correspond. Further, in some examples, the one or more first indication 608 and/or one or more second indications 610 may be provided with temporal information corresponding to when source data associated with the indications 608, 610 was generated and/or stored (e.g., when an email was sent, when a call took place, when a person was at a given location, etc.).

At the second degree of episodic memory, shown in FIG. 6B, the number of one or more first indications 608 and/or second indications 610 may differ from when the slider 606 is at the first degree of episodic memory. Accordingly, a number of content data that are determined to be landmark memories may be altered based on when a specified degree of episodic memory is altered.

The one or more first indications 608 and/or second indications 610 may be received from an episodic memory, such as the episodic memory 310 described with respect to FIG. 3. For example, the episodic memory may be generated using content data that is embedded, ranked, and/or weighted, such as based on semantic context. The content data may be ranked based on dissimilarity between the content data, such as via distance formulas, text comparisons, visual comparisons, and/or other comparison techniques that may be recognized by those of ordinary skill in the art.

Memories can be organized to provide efficient handles into massive quantities of stored content that are efficiently available via being pointed at by memories which are landmark memories (e.g., pointed at via the first indications 608). Such richer memories (e.g., landmark memories) can be progressively more detailed via less efficient processes of drilling into larger memory encodings, such as by altering the slider 606. In this role, a limited retrieval and reasoning systems can work efficiently at the level of landmark memories, and use the landmark memories in identifying relevant content, and making decisions to perform effortful deep dives into less structured, harder to retrieve details at which the landmark memories point. In this respect, as an example, the indications 608 that correspond to landmark memories may include information corresponding to a relationship with the second indications 610 that do not correspond to landmark memories, such that desired memories associated with landmark memories can be retrieved or otherwise used to perform an action.

FIG. 7 illustrates an example method for retrieving information, such as landmark memories, from an episodic object memory, according to some aspects described herein. In examples, aspects of method 700 are performed by a device, such as a computing device 102 and/or server 104, discussed above with respect to FIG. 1.

Method 700 begins at operation 702, wherein a user-interface (such as user-interface 602) is generated. The user-interface may be a graphical user-interface (GUI) that is displayed on a screen of a computing device (e.g., the computing device) 602. Alternatively, the user-interface may be a touchpad, mechanical buttons, a camera, a microphone, or any other interface that is configured to receive user input.

At operation 704, an input is received, via the user-interface. The input corresponds to a degree of episodic memory. For example, the user-interface may include a slider and the input may correspond to a location or movement of the slider. The location or movement of the slider may be associated with a degree of episodic memory. In other examples, the input may be a voice command, text, automated skill, gaze command, gesture, or the like that is associated with a degree of episodic memory.

At operation 706, it is determined if there is a search results, from an episodic object memory, that corresponds to the input. If it is determined that there is not a search results, from the episodic object memory, that corresponds to the input, flow branches “NO” to operation 708, where a default action is performed. For example, the input and/or episodic object memory, may have an associated pre-configured action. In other examples, method 700 may comprise determining whether the input and/or episodic object memory have an associated default action, such that, in some instances, no action may be performed as a result of the received query. Method 700 may terminate at operation 708. Alternatively, method 700 may return to operation 702 or 704 to provide an iterative loop.

If however, it is determined that there are search results from the episodic object memory that correspond to the input, flow instead branches “YES” to operation 710, where, an indication of one or more landmark memories are received based on the degree of episodic object memory. For example, the indication of one or more landmark memories may be similar to the first indications 608 discussed with respect to FIG. 6. Additionally, or alternatively, the indications may be provided as an output, such as in a report, which may be used for further processing.

In some examples, after receiving an indication of the one or more landmark memories, mechanisms provided herein may be used to search data associated with the landmark memories. For example, if a specific landmark memory is associated with content data at a specific moment in time, then other content data from within a specified time range of that specific landmark memory may be searched (e.g., based on a query, which may be provided by a user). Generally, once a landmark memory is located, it may act as a pivot point on which searched may be conducted to other data that is either referenced in a storage location of the landmark memory and/or other data that is otherwise determined to be associated with the landmark memory.

In some examples, the episodic object memory is generated using content data that is embedded, ranked, weighted, and/or scored, such as based on semantic context. The embeddings generated based on the content data may be ranked, weighted, and/or scored based on a dissimilarity of an embedding to at least one other embedding. The content data may include one or more of audio content data, visual content data, gaze content data, weather content data, news content data, calendar content data, email content data, or location content data. Further, the episodic object memory may be stored at a location that is different than the location of source data corresponding to the content items.

In some examples, the input is a first input, the degree of episodic memory is a first degree of episodic memory, the indication is a first indication, and the method 700 further includes receiving a second input that corresponds to a second degree of episodic memory. Subsequently, a second indication of one or more landmark memories corresponding to the second input, may be received from the episodic object memory based on the second degree of episodic memory.

In some examples, landmark memories give systems the ability to have a dialog (e.g., with a human or another system) in a conversational chat setting that would help to narrow down to which landmark memory of a plurality of landmark memories a human or system is referring. In some examples, the dialog could help to clarify ambiguity when retrieving information associated with a landmark memory. For example, when questioned about an experience at a restaurant, a system may provide a prompt stating “do you mean the last time you were at Restaurant X in September, or when you were there with Person A and Person B?” Accordingly, systems provided herein may request feedback to obtain information for determining which landmark memory is intended to be located (e.g., in an episodic object memory). In some examples, a mutually shared handle of a library of salient landmark memories enables the dialog with an AI system that has access to a model of an agent's (e.g., human or system's) own episodic memory. In such examples, the same language may be used to refer to the episodic object memory of the agent that is shared (at least in part or approximately) with the AI system.

Method 700 may terminate at operation 710. Alternatively, method 700 may return to operation 702 (or any other operation from method 700) to provide an iterative loop, such as of generating a user-interface, receiving a query with information that corresponds to at least two different content types, and receiving search results, such as from an episodic object memory, that correspond to the query.

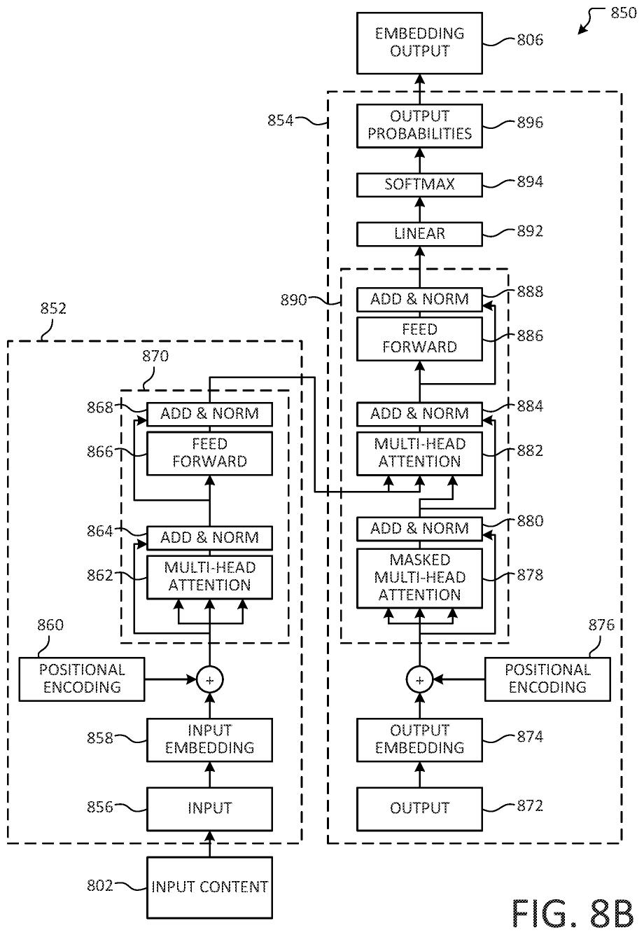

FIGS. 8A and 8B illustrate overviews of an example generative machine learning model that may be used according to aspects described herein. With reference first to FIG. 8A, conceptual diagram 800 depicts an overview of pre-trained generative model package 804 that processes an input 802 to generate model output for storing entries (e.g., landmark memories) in and/or retrieving information (e.g., landmark memories) from an episodic object memory 806 according to aspects described herein. Examples of pre-trained generative model package 604 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 804 is pre-trained according to a variety of inputs (e.g., a variety of human languages, a variety of programming languages, and/or a variety of content types) and therefore need not be finetuned or trained for a specific scenario. Rather, generative model package 804 may be more generally pre-trained, such that input 802 includes a prompt that is generated, selected, or otherwise engineered to induce generative model package 804 to produce certain generative model output 806. For example, a prompt includes a context and/or one or more completion prefixes that thus preload generative model package 804 accordingly. As a result, generative model package 804 is induced to generate output based on the prompt that includes a predicted sequence of tokens (e.g., up to a token limit of generative model package 804) relating to the prompt. In examples, the predicted sequence of tokens is further processed (e.g., by output decoding 816) to yield output 806. For instance, each token is processed to identify a corresponding word, word fragment, or other content that forms at least a part of output 806. It will be appreciated that input 802 and generative model output 806 may each include any of a variety of content types, including, but not limited to, text output, image output, audio output, video output, programmatic output, and/or binary output, among other examples. In examples, input 802 and generative model output 806 may have different content types, as may be the case when generative model package 804 includes a generative multimodal machine learning model.

As such, generative model package 804 may be used in any of a variety of scenarios and, further, a different generative model package may be used in place of generative model package 804 without substantially modifying other associated aspects (e.g., similar to those described herein with respect to FIGS. 1-7). Accordingly, generative model package 804 operates as a tool with which machine learning processing is performed, in which certain inputs 802 to generative model package 804 are programmatically generated or otherwise determined, thereby causing generative model package 804 to produce model output 806 that may subsequently be used for further processing.

Generative model package 804 may be provided or otherwise used according to any of a variety of paradigms. For example, generative model package 804 may be used local to a computing device (e.g., computing device 102 in FIG. 1) or may be accessed remotely from a machine learning service. In other examples, aspects of generative model package 804 are distributed across multiple computing devices. In some instances, generative model package 804 is accessible via an application programming interface (API), as may be provided by an operating system of the computing device and/or by the machine learning service, among other examples.

With reference now to the illustrated aspects of generative model package 804, generative model package 804 includes input tokenization 808, input embedding 810, model layers 812, output layer 814, and output decoding 816. In examples, input tokenization 808 processes input 802 to generate input embedding 810, which includes a sequence of symbol representations that corresponds to input 802. Accordingly, input embedding 810 is processed by model layers 812, output layer 814, and output decoding 816 to produce model output 806. An example architecture corresponding to generative model package 804 is depicted in FIG. 8B, which is discussed below in further detail. Even so, it will be appreciated that the architectures that are illustrated and described herein are not to be taken in a limiting sense and, in other examples, any of a variety of other architectures may be used.

FIG. 8B is a conceptual diagram that depicts an example architecture 850 of a pre-trained generative machine learning model that may be used according to aspects described herein. As noted above, any of a variety of alternative architectures and corresponding ML models may be used in other examples without departing from the aspects described herein.

As illustrated, architecture 850 processes input 802 to produce generative model output 806, aspects of which were discussed above with respect to FIG. 8A. Architecture 850 is depicted as a transformer model that includes encoder 852 and decoder 854. Encoder 852 processes input embedding 858 (aspects of which may be similar to input embedding 810 in FIG. 8A), which includes a sequence of symbol representations that corresponds to input 856. In examples, input 856 includes input content 802 corresponding to a type of content, aspects of which may be similar to input data 111, virtual content 200, and/or real content 250.

Further, positional encoding 860 may introduce information about the relative and/or absolute position for tokens of input embedding 858. Similarly, output embedding 874 includes a sequence of symbol representations that correspond to output 872, while positional encoding 876 may similarly introduce information about the relative and/or absolute position for tokens of output embedding 874.

As illustrated, encoder 852 includes example layer 870. It will be appreciated that any number of such layers may be used, and that the depicted architecture is simplified for illustrative purposes. Example layer 870 includes two sub-layers: multi-head attention layer 862 and feed forward layer 866. In examples, a residual connection is included around each layer 862, 866, after which normalization layers 864 and 868, respectively, are included. Decoder 854 includes example layer 890. Similar to encoder 852, any number of such layers may be used in other examples, and the depicted architecture of decoder 854 is simplified for illustrative purposes. As illustrated, example layer 890 includes three sub-layers: masked multi-head attention layer 878, multi-head attention layer 882, and feed forward layer 886. Aspects of multi-head attention layer 882 and feed forward layer 886 may be similar to those discussed above with respect to multi-head attention layer 862 and feed forward layer 866, respectively. Additionally, masked multi-head attention layer 878 performs multi-head attention over the output of encoder 852 (e.g., output 872). In examples, masked multi-head attention layer 878 prevents positions from attending to subsequent positions. Such masking, combined with offsetting the embeddings (e.g., by one position, as illustrated by multi-head attention layer 882), may ensure that a prediction for a given position depends on known output for one or more positions that are less than the given position. As illustrated, residual connections are also included around layers 878, 882, and 886, after which normalization layers 880, 884, and 888, respectively, are included.

Multi-head attention layers 862, 878, and 882 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 8B (e.g., by a corresponding normalization layer 864, 880, or 884).

Feed forward layers 866 and 886 may each be a fully connected feed-forward network, which applies to each position. In examples, feed forward layers 866 and 886 each include a plurality of linear transformations with a rectified linear unit activation in between. In examples, each linear transformation is the same across different positions, while different parameters may be used as compared to other linear transformations of the feed-forward network.

Additionally, aspects of linear transformation 892 may be similar to the linear transformations discussed above with respect to multi-head attention layers 862, 878, and 882, as well as feed forward layers 866 and 886. Softmax 894 may further convert the output of linear transformation 892 to predicted next-token probabilities, as indicated by output probabilities 896. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 804 in FIG. 8A or encoder 852 and decoder 854 in FIG. 8B) to generate a series of output tokens (e.g., words), for example which are then combined to yield a complete sentence (and/or any of a variety of other content). It will be appreciated that other generative models may generate multiple output tokens in a single iteration and may thus use a reduced number of iterations or a single iteration.

Accordingly, output probabilities 896 may thus form embedding output 806 according to aspects described herein, such that the output of the generative ML model (e.g., which may include structured output) is used as input for determining an action according to aspects described herein. In other examples, embedding output 806 is provided as generated output for updating an episodic object memory.

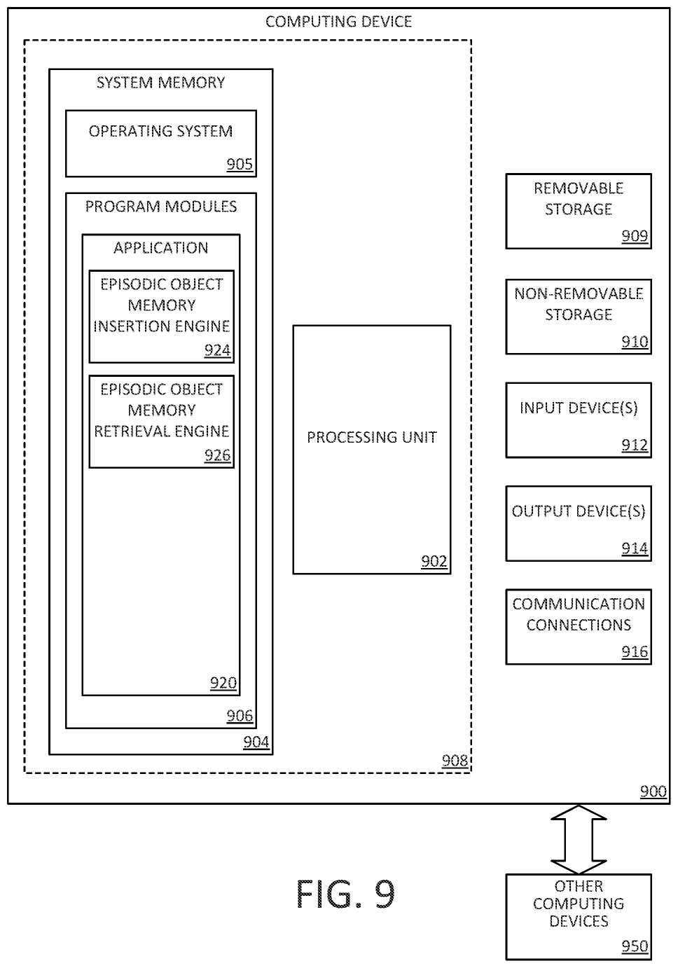

FIGS. 9-11 and the associated descriptions provide a discussion of a variety of operating environments in which aspects of the disclosure may be practiced. However, the devices and systems illustrated and discussed with respect to FIGS. 9-11 are for purposes of example and illustration and are not limiting of a vast number of computing device configurations that may be utilized for practicing aspects of the disclosure, described herein.

FIG. 9 is a block diagram illustrating physical components (e.g., hardware) of a computing device 900 with which aspects of the disclosure may be practiced. The computing device components described below may be suitable for the computing devices described above, including computing device 102 in FIG. 1. In a basic configuration, the computing device 900 may include at least one processing unit 902 and a system memory 904. Depending on the configuration and type of computing device, the system memory 904 may comprise, but is not limited to, volatile storage (e.g., random access memory), non-volatile storage (e.g., read-only memory), flash memory, or any combination of such memories.

The system memory 904 may include an operating system 905 and one or more program modules 906 suitable for running software application 920, such as one or more components supported by the systems described herein. As examples, system memory 904 may store episodic object memory insertion engine or component 924 and/or episodic object memory retrieval engine or component 926. The operating system 905, for example, may be suitable for controlling the operation of the computing device 900.

Furthermore, aspects of the disclosure may be practiced in conjunction with a graphics library, other operating systems, or any other application program and is not limited to any particular application or system. This basic configuration is illustrated in FIG. 9 by those components within a dashed line 908. The computing device 900 may have additional features or functionality. For example, the computing device 900 may also include additional data storage devices (removable and/or non-removable) such as, for example, magnetic disks, optical disks, or tape. Such additional storage is illustrated in FIG. 9 by a removable storage device 909 and a non-removable storage device 910.

As stated above, a number of program modules and data files may be stored in the system memory 904. While executing on the processing unit 902, the program modules 906 (e.g., application 920) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 9 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 900 on the single integrated circuit (chip). Some aspects of the disclosure may also be practiced using other technologies capable of performing logical operations such as, for example, AND, OR, and NOT, including but not limited to mechanical, optical, fluidic, and quantum technologies. In addition, some aspects of the disclosure may be practiced within a general purpose computer or in any other circuits or systems.

The computing device 900 may also have one or more input device(s) 912 such as a keyboard, a mouse, a pen, a sound or voice input device, a touch or swipe input device, etc. The output device(s) 914 such as a display, speakers, a printer, etc. may also be included. The aforementioned devices are examples and others may be used. The computing device 900 may include one or more communication connections 916 allowing communications with other computing devices 950. Examples of suitable communication connections 916 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 904, the removable storage device 909, and the non-removable storage device 910 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 900. Any such computer storage media may be part of the computing device 900. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

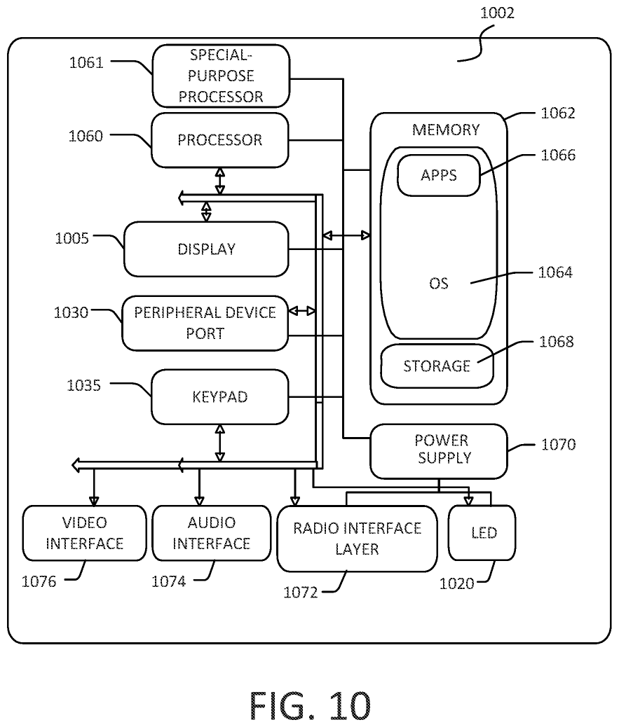

FIG. 10 is a block diagram illustrating the architecture of one aspect of a computing device. That is, the computing device can incorporate a system (e.g., an architecture) 1002 to implement some aspects. In some examples, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000 described herein (e.g., an embedding object memory insertion engine, an embedding object memory retrieval engine, etc.).

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 1020 may be used to provide visual notifications, and/or an audio interface 1074 may be used for producing audible notifications via the audio transducer 1025. In the illustrated example, the visual indicator 1020 is a light emitting diode (LED) and the audio transducer 1025 is a speaker. These devices may be directly coupled to the power supply 1070 so that when activated, they remain on for a duration dictated by the notification mechanism even though the processor 1060 and/or special-purpose processor 1061 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 1025, the audio interface 1074 may also be coupled to a microphone to receive audible input, such as to facilitate a telephone conversation. In accordance with aspects of the present disclosure, the microphone may also serve as an audio sensor to facilitate control of notifications, as will be described below. The system 1002 may further include a video interface 1076 that enables an operation of an on-board camera 1030 to record still images, video stream, and the like.

A computing device implementing the system 1002 may have additional features or functionality. For example, the computing device may also include additional data storage devices (removable and/or non-removable) such as, magnetic disks, optical disks, or tape. Such additional storage is illustrated in FIG. 10 by the non-volatile storage area 1068.

Data/information generated or captured by the computing device and stored via the system 1002 may be stored locally on the computing device, as described above, or the data may be stored on any number of storage media that may be accessed by the device via the radio interface layer 1072 or via a wired connection between the computing device and a separate computing device associated with the computing device, for example, a server computer in a distributed computing network, such as the Internet. As should be appreciated such data/information may be accessed via the computing device via the radio interface layer 1072 or via a distributed computing network. Similarly, such data/information may be readily transferred between computing devices for storage and use according to well-known data/information transfer and storage means, including electronic mail and collaborative data/information sharing systems.

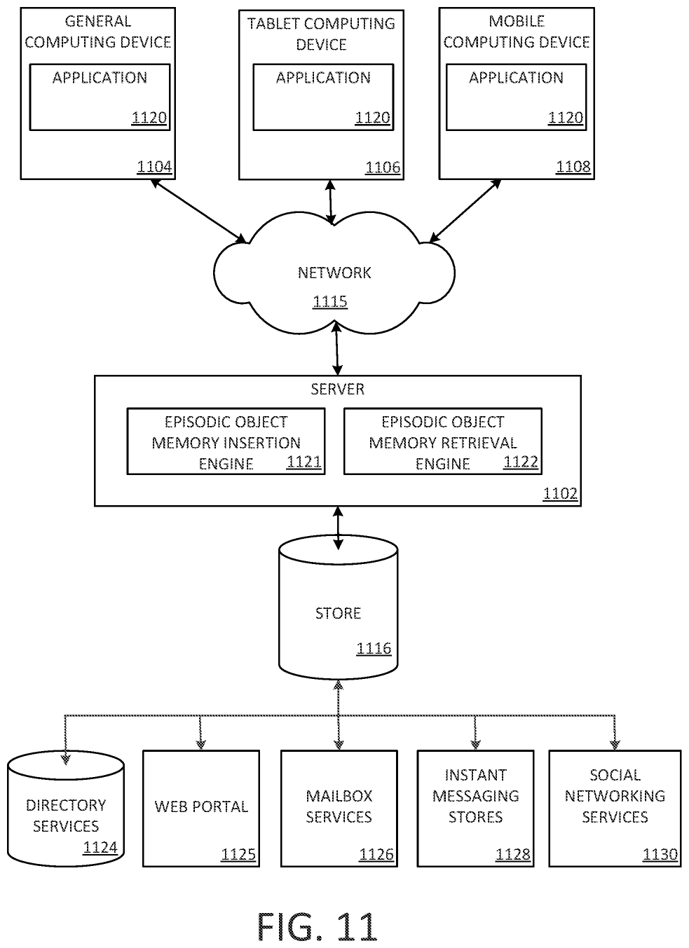

FIG. 11 illustrates one aspect of the architecture of a system for processing data received at a computing system from a remote source, such as a personal computer 1104, tablet computing device 1106, or mobile computing device 1108, as described above. Content displayed at server device 1102 may be stored in different communication channels or other storage types. For example, various documents may be stored using a directory service 1124, a web portal 1125, a mailbox service 1126, an instant messaging store 1128, or a social networking site 1130.

An application 1120 (e.g., similar to the application 920) may be employed by a client that communicates with server device 1102. Additionally, or alternatively, episodic object memory insertion engine 1121 and/or episodic object memory retrieval engine 1122 may be employed by server device 1102. The server device 1102 may provide data to and from a client computing device such as a personal computer 1104, a tablet computing device 1106 and/or a mobile computing device 1108 (e.g., a smart phone) through a network 1115. By way of example, the computer system described above may be embodied in a personal computer 1104, a tablet computing device 1106 and/or a mobile computing device 1108 (e.g., a smart phone). Any of these examples of the computing devices may obtain content from the store 1116, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for storing a landmark memory embedding in an episodic object memory, the method comprising:
receiving one or more content items, the content items each having one or more content data;
providing the one or more content data associated with the one or more content items to one or more embedding models, wherein the one or more embedding models generate one or more embeddings;
receiving, from one or more of the embedding models, a collection of embeddings, wherein each embedding of the collection of embeddings corresponds to at least one content data from a respective content item;
determining that one or more embeddings of the collection of embeddings are landmark memory embeddings;
inserting the one or more landmark memory embeddings into the episodic object memory, wherein the one or more landmark memory embeddings are associated with a reference to related data associated with the one or more landmark memory embeddings; and
providing the episodic object memory.

2. The method of claim 1, wherein the insertion triggers a spatial storage operation to store a vector representation of the landmark memory embeddings, and wherein the vector representation is stored in at least one of an approximate nearest neighbor (ANN) tree, a k-d tree, or a multidimensional tree.

3. The method of claim 1, wherein the determining comprises ranking the one or more of the embeddings based on a dissimilarity to at least one of the other embeddings of the collection of embeddings, and wherein the inserting comprises storing an indication of the rankings corresponding to the landmark memory embeddings.

4. The method of claim 1, wherein the determining comprises:
obtaining a machine-learning model that was previously-trained to identify landmark memories;
providing the collection of embeddings to the machine-learning model;
receiving a score from the machine-learning model corresponding to a degree to which embeddings are landmark memory embeddings;
comparing the score to a threshold to identify that one or more embeddings of the collection of embeddings are landmark memory embeddings.

5. The method of claim 4, further comprising, prior to the comparing:
receiving user-input corresponding to the threshold, wherein the threshold is a threshold of episodic memory.

6. The method of claim 5, wherein the user-input is received from a slider of a graphical user-interface.

7. The method of claim 1, wherein the content data are one or more of audio content data, visual content data, gaze content data, weather content data, news content data, calendar content data, email content data, or location content data.

8. The method of claim 1, wherein the episodic object memory is stored at a location that is different than a location of source data corresponding to the content items.

9. The method of claim 1, wherein the one or more landmark memory embeddings comprise a set of properties that define a schema.

10. The method of claim 9, wherein the set of properties comprise a summary of the landmark memory embeddings and the reference to related data.

11. A method for retrieving landmark memories from an episodic object memory, the method comprising:
generating a user-interface;
receiving, via the user-interface, an input, wherein the input corresponds to a degree of episodic memory,
receiving, from the episodic memory, an indication of one or more landmark memories, based on the degree of episodic memory,
wherein the episodic object memory is generated using content data that is embedded and ranked, based on semantic context.

12. The method of claim 11, wherein the embeddings generated based on the content data are ranked based on a dissimilarity of an embedding to at least one other embedding.

13. The method of claim 11, wherein the content data are one or more of audio content data, visual content data, gaze content data, weather content data, news content data, calendar content data, email content data, or location content data.

14. The method of claim 11, wherein the episodic object memory is stored at a location that is different than a location of source data corresponding to the content items.

15. The method of claim 11, wherein the input is a first input, wherein the degree is a first degree, wherein the indication is a first indication, and wherein the method further comprises:
receiving a second input, wherein the second input corresponds to a second degree of episodic memory; and
receiving, from the episodic object memory, a second indication of one or more landmark memories corresponding to the second input, based on the second degree of episodic memory.

16. The method of claim 15, wherein the user-interface includes a slider and wherein the first and second inputs correspond to movements of the slider.

17. A method for storing landmark memories in and retrieving landmark memories from an episodic object memory, the method comprising:
receiving one or more content items, the content items each having one or more content data;
providing the one or more content data associated with the one or more content items to one or more embedding models, wherein the one or more embedding models generate one or more embeddings;
receiving, from one or more of the embedding models, a collection of embeddings, wherein each embedding of the collection of embeddings corresponds to at least one content data from a respective content item;
determining that one or more embeddings of the collection of embeddings are landmark memory embeddings;
inserting the one or more landmark memory embeddings into the episodic object memory; and
receiving an input, wherein the input corresponds to a degree of episodic memory, receiving, from the episodic object memory, an indication of one or more landmark memories, based on the degree of episodic memory.

18. The method of claim 17, wherein the insertion triggers a spatial storage operation to store a vector representation of the landmark memory embeddings, and wherein the vector representation is stored in at least one of an approximate nearest neighbor (ANN) tree, a k-d tree, or a multidimensional tree.

19. The method of claim 17, wherein the determining comprises weighting the one or more embeddings based on a dissimilarity to at least one of the other embeddings of the collection of embeddings.

20. The method of claim 17, wherein the determining comprises:
obtaining a machine-learning model that was previously-trained to identify landmark memories;
providing the collection of embeddings to the machine-learning model;
receiving a score from the machine-learning model corresponding to a degree to which embeddings are landmark memory embeddings;
comparing the score to a threshold to identify that one or more embeddings of the collection embeddings are landmark memory embeddings.
